(19) United States
(12) Patent Application Publication
(10) Pub. No.: US 2020/0060934 A1
(43) Pub. Date: Feb. 27, 2020

(54) MEDICAL BAG WITH TWO COMPARTMENTS AND INCLUDING A TAB

(71) Applicant: Technoflex, Bidart (FR)

(72) Inventors: Fabien Pruvot, Saint Pee Sur Nivelle (FR); Emmanuel Arnault, Tarnos (FR)

(21) Appl. No.: 16/461,580

(22) PCT Filed: Nov. 13, 2017
(86) PCT No.: PCT/FR2017/053088

§ 371 Date: May 16, 2019

(51) Int. Cl. A61J 1/20; A61J 1/10; A61J 1/14

(52) U.S. Cl. CPC A61J 1/2093; A61J 1/1475; A61J 1/2024; A61J 1/10

(57) ABSTRACT

A medical bag having at least two compartments, a peelable seal between the compartments, a permanent seal on the contour of the bag and at least one filling tube further comprising an opening with no seal on one of the compartments. The at least one tube for filling, comprises an opening with no seal on one of the compartments, and it comprises two labels on the compartment, a label being located on the rear side and the other label being located on the front face of the bag, the opening onto one of the compartments constituting a film excess on top of a label, the excess being sealed only on one of the sides, but not horizontally and being flexible enough to facilitate easy opening.

### FIELD OF THE INVENTION

The present invention relates to the field of medical bags. The present invention relates more particularly to a medical bag with two compartments and including a tab.

### PRIOR ART

Bags for medical use with two compartments are known in the prior art. For example, one of the two compartments is filled with a liquid (diluent) and the other compartment contains a powder (drug).

The prior art known from U.S. Pat. No. 6,468,377 B1, is a flexible container for storage and administration of medical solutions. The container comprises a transparent front sheet consisting of a flat layer of a polymer and an opposite back sheet. The back sheet is made of a flat laminate layer. The front and rear sheets are sealed together along a common peripheral edge to form a volume enclosure. The volume enclosure is made of materials having barrier properties to oxygen and moisture which make it possible for the thermoplastic material of the container to be stored for extended periods of time without degrading the contents. The volume enclosure is then inflated with a pressurised gas to stretch permanently the front and rear sheets outwardly and thereby to increase the volume capacity of the recipient. An alternative embodiment of the recipient comprises multiple compartments separated by moveable seals, for containing a diluent and a medicament. The seals are ruptured by manipulation of the recipient to mix the contents and at the same time for administration to a patient by means of an IV type arrangement. Lateral side tubes are provided for filling the bag, as shown in FIG. 6 of this prior art US patent. On said FIG. 6, a connector/tube for filling the container with liquid and a connector/tube for filling the container with powder can be seen. The filling compartment is then removed/cut and then sealed to obtain the finished product, as shown in FIGS. 1 and 2 of this prior art US patent.

### DISCLOSURE OF THE INVENTION

The present invention intends to overcome the disadvantages of the prior art by providing a medical bag with two compartments for easier filling.

To this end, the present invention relates, in its most general sense, to a medical bag having at least two compartments, a peelable seal between the compartments, a permanent seal on the contour of said bag and at least one filling tube further comprising an opening with no seal on one of the compartments.

This opening having no seal on one of the compartments, hereafter called “tab” makes filling easier. Indeed, during filling, a specific opening system, for example suction cups, is positioned on the bag to spread the front part of the rear section and to make it possible to insert a filling nozzle. This opening system requires having the most flexible possible films, hence the importance of not placing aluminium in this area.

Moreover, if the excess was not present, there would be a risk of filling the container with powder between the aluminium and the bag, which is not desirable.

This excess actually makes it possible to properly open and insert the powder between the two transparent films.

Preferably, the compartment having said opening is intended to receive a powder.

Advantageously, said bag comprises two labels located on the compartment for receiving a powder, one label being located on the rear side and the other label being located on the front side of said bag.

According to one embodiment, said bag is made from two transparent films before said labels are placed thereon.

The fact of using a transparent film in direct contact with the powder and the liquid makes it possible to better comply with regulatory standards, insofar as it is more inert material and less contaminating. The complex containing aluminium, present in the labels, is not in direct contact with the solution, unlike the bags of the prior art.

According to an embodiment, said bag implements a complex/overpack for packaging said filled bag. This increases the service life and protects the bag from outside contamination.

Advantageously, the other compartment is intended to receive a liquid and said bag is transparent in the portion of the bag which receives said liquid, and is also transparent in the portion of the bag receiving said powder when said labels are removed. This makes a visual check possible.

According to an embodiment, said bag is adapted to be folded and to be kept folded thanks to the overpack. This allows the peelable seal to be protected.

Advantageously, said liquid is located in the bottom of the bag. If used without breaking the peelable seal, then only the liquid, which is a solvent, for example a sugared salt water, will be administered to the patient without risk.

According to a particular mode of implementation, said bag comprises means that make it possible, upon rupture of said peelable seal, for the entire width of said peelable seal to not yield under pressure. This causes a liquid inlet jet often located in the middle of the peelable seal. Said jet generates a vortex that facilitates the homogenisation of the powder into the solution.

Alternatively, at least one of the labels is sealed to said bag, and, when the label is being sealed onto said bag, the label is held by a suction device, the bag being then put into position after which the seal is made. This holding via suction makes a robust and repeatable process possible when sealing the label onto the bag.

Alternatively, at least one of the labels is sealed to said bag after filling of said bag. This makes it possible for the entity that fills the bag to monitor the filling process (“visual inspection” in English terminology) before applying the labels.

Advantageously, at least one of the two labels is peelable, that is to say, it is capable of being removed before use of said bag. These labels have the same level of adhesion, regardless pf the temperature used during the sealing process, as a peelable film is used as an inner layer of said label.

According to an embodiment, said opening does not present any horizontal seal on one of the compartments.

According to another embodiment, said opening does not have any vertical seal on one of the compartments.

According to an embodiment, said bag comprises two compartments.

### BRIEF DESCRIPTION OF THE DRAWINGS

The invention will be better understood using the description given hereinafter for purely explanatory purposes, of an embodiment of the invention, with reference to the Figures in which:

FIG. 1 shows the bag of present invention in one embodiment;

FIG. 2 shows the bag according to the present invention, with two labels sealed to the upper part in one embodiment; and

FIG. 3 shows a bag compartment according to the present invention after filling, in one embodiment.

### DETAILED DESCRIPTION OF EMBODIMENTS OF INVENTION

The present invention relates to a bag 10 for medical purposes having at least two compartments 11, 12, a peelable seal 13 between the compartments 11, 12, a permanent seal 14 around the edge of said bag 10 and at least one filling tube 15, further comprising an opening 16 having no seal on one of the two compartments 11, 12.

In one embodiment, said opening 16 does not have any horizontal seal on one of the compartments 11, 12.

In another embodiment, said opening 16 does not have any vertical seal on one of the compartments 11,12.

In one embodiment, said bag comprises two compartments 11, 12.

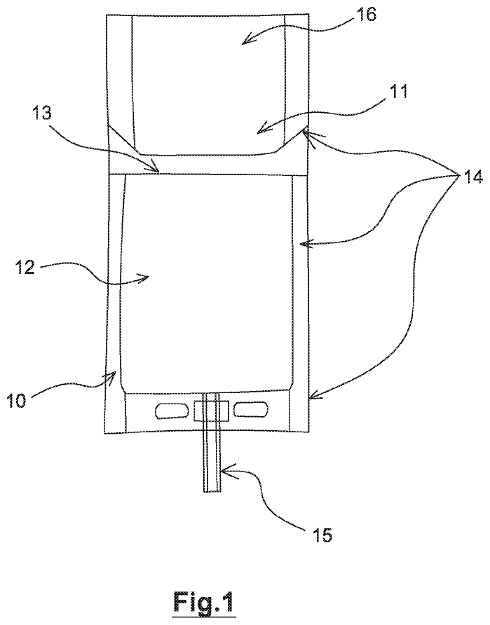

FIG. 1 illustrates the bag 10 according to the present invention, in one embodiment. It is observed in FIG. 1 that the bag 10 of the present invention comprises two compartments and 12, a peelable seal 13 which can be broken under pressure, a permanent seal 14 around the edge of said bag 10 and a filling tube 15. Also shown in FIG. 1, the bag 10 of the present invention includes an opening 16 having no horizontal seal on the compartment 11.

The bag 10 according to the present invention exhibits permanent seals, the peelable seals (poor sealing intended to be broken upon final use) and also an opening called a tab which does not present any horizontal seal.

In one embodiment, the bag 10 according to the present invention has a filling tube and a “tab” on the top of the bag making it possible to open the bag along its entire width; this will also make it possible to fill the container with one of the components.

The compartment 12 of the bag 10 according to the present invention comprising a tube 15 is filled through the tube 15 according to a standard method, the compartment 11 comprising the tab is filled by separating the two films and then incorporating a filling nozzle in the bag.

Once this filling is done, the filling nozzle is removed so that a sealing tool makes a seal, at least, on the upper part of the bag and, at most, along the entire width thereof.

In one embodiment, the bag 10 according to the present invention comprises an open area that does not represent the entire width of the bag 10.

In one embodiment, the bag 10 of the present invention also has labels, one on the back and one on the front of the bag. These labels are located on the compartment which will receive the powder (compound sensitive to water vapor, light and oxygen and therefore requiring the presence of an aluminium barrier).

These labels are used to provide additional protection to the powder, with respect to the protection of the transparent plastic film alone INERTA 108, and may be sealed to the bag either before or after filling the bag 10.

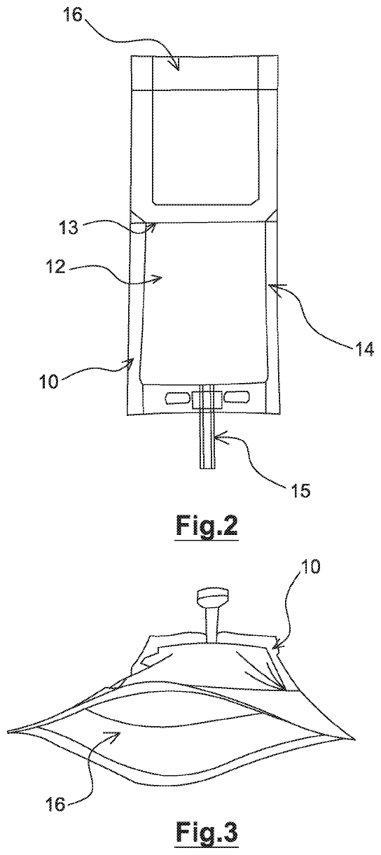

FIG. 2 shows the bag according to the present invention, with two labels sealed on the upper part, in one embodiment.

FIG. 2 shows the label aluminium, a sealed zone of the label and seals on three sides for a holding the label on the front bag.

If it is positioned prior to filling, the label is sealed on at most three sides simply because the bag 10 according to the present invention does not have areas capable of receiving a sealing prior to filling the container with powder on the upper part. While the fourth seal of the label was performed by heat transfer, a seal inside the compartment (between the two transparent films) would also be present and would block the filling. However, if the label(s) are placed after filling, one can imagine that during the placement of these labels, the four seals will be done simultaneously.

The label is sealed to a portion of the powder compartment to allow the tabs to go therebeyond, which is necessary if the tags are sealed before filling, and optional if they are sealed after filling.

FIG. 3 illustrates a bag compartment according to the present invention after filling, in one embodiment.

FIG. 3 shows the excess of the film going beyond the tab.

The excess of film going beyond the tab makes it possible to provide a proper opening and makes it possible to fill the container with powder between the two transparent films. In section, the structure looks like this:

Alu (INERTA 161)/transparent film (INERTA108)/Powder/transparent film (INERTA108)/Alu (INERTA 161)

It is necessary to avoid putting the powder between the aluminium and the transparent film, which this tab makes possible.

The filler device should be a machine capable of adroitly making said opening. For example, a suction system applied to the tab can be adapted to make it possible to open the compartment.

This excess of film going therebeyond is not only used for the filling. It also increases the size of the powder compartment to reduce powder drifting onto the seal area. This dust is indeed a contaminant and a troublesome element for achieving a reliable seal.

Said tab also makes it possible to seal the top bag and to make the hanging hole. After sealing the top of the bag with a wide seal, a portion thereof may be perforated to make the hanging hole (hole for hanging the bag in hospitals).

The sealing of the bag makes it possible to finish attaching the labels and to seal the powder compartment under the label. It is wide enough to cover both the transparent area and the label area. Indeed, the powder should not be able to back up into the tab (transparent portion), which would not then be protected by the aluminium.

It is in this tab that the suspension hole is then made.

The opening 16 does not have any horizontal or vertical seal on any of the compartments 11, 12, also referred to as “tab” is an excess where the film/bag goes beyond the top of the label (at least on an empty bag). If it is desirable to have bags without labels and place said labels after filling, this excess will be present but not identifiable as an excess going beyond the label but as a longer bag length.

This excess may be visible before or after filling, because the labels themselves may be made before and after filling.

This excess is only sealed on both sides but not horizontally, and is flexible enough to allow easy opening.

This tab will be made with a material compatible with pharmaceutical products to ensure compatibility with the component placed in the bag, and is sealed after filling.

In one embodiment, a suspension hole is formed in this tab.

Empty bags made with the tab are produced and packaged in a clean room to avoid particulate contamination inside the bag that could occur since a portion thereof is open.

Furthermore, in one embodiment, the tab is covered with aluminium labels where removal of the labels takes place after filling.

The dimensions, and in particular the height, of this tab will be defined so as to avoid the presence of residues in this area after filling.

The transparent film used for this strip is a film compatible with pharmaceutical products, for example INERTA 108, and may be sealed to make it possible to store solution. In one embodiment, the film is “peelable” in order to realise the peelable seals.

In one embodiment, the bag 10 according to the present invention comprises a filler tube at said tab to facilitate filling of the container with powder.

In one embodiment, the compartment 11 with said opening 16 for receiving a powder.

In one embodiment, the bag 10 according to the present invention comprises two labels located on the compartment 11 for receiving a powder, a label being located on the rear side and the other label being located on the front face of said bag 10.

In one embodiment, the bag 10 according to the present invention is made from two transparent films before depositing said labels.

In one embodiment, the bag 10 according to the present invention uses a complex/overpack for packaging said filled bag.

In one embodiment, the other compartment 12 is intended to receive a liquid and said bag is transparent in the portion of the bag 10 which receives said liquid, and is also transparent in the portion of the bag 10 which receives said powder when said labels are removed.

In one embodiment, the bag 10 according to the present invention is adapted to be folded and to be kept folded thanks to the overpack.

In one embodiment, said liquid is located on the bottom of the bag.

In one embodiment, the bag 10 according to the present invention comprises means for, upon breaking of said peelable seal 13, the entire width of said peelable seal 13 does not yield under pressure.

In one embodiment, at least one label is sealed on said bag 10 and, during the sealing process of the label on said bag 10, the label is held by a suction device, the bag is then positioned and the seal is made.

In one embodiment, at least one of the labels is sealed to said bag 10 after filling of said bag 10.

In one embodiment, at least one of the two labels is peelable, that is to say, it is adapted to be removed before use of said bag 10.

The label(s) reinforce(s) the peelable seal which separates the components (the force/pressure required to open this peel is greater with the label(s) or without). This reinforces the protection of the peelable seal that should not yield before removing the labels and use thereof.

The invention is described in the foregoing by way of example. It is understood that a person skilled in the art is able to produce different variants of the invention without departing from the scope of the patent.

1. A bag (10) for medical purposes having at least two compartments (11, 12), a peelable seal (13) between the compartments (11, 12), a permanent seal (14) on the contour of said bag (10) and at least one tube (15) for filling, characterised in that it comprises an opening (16) with no seal on one of the compartments (11, 12), and in that it comprises two labels on the compartment (11), a label being located on the rear side and the other label being located on the front face of said bag (10), the opening (16) onto one of the compartments (11, 12) constituting a film excess on top of a label, said excess being sealed only on one of the sides, but not horizontally and being flexible enough to facilitate easy opening.

2. A bag (10) for medical purposes having at least two compartments (11, 12) according to claim 1, characterised in that it is manufactured from two transparent films prior to the placement of said labels.

3. A bag (10) for medical purposes having at least two compartments (11, 12) according to one of the preceding claims, characterised in that it comprises means so that, upon breaking of said peelable seal (13), the entire width of said peelable seal (13) does not yield under pressure.

4. A bag (10) for medical purposes having at least two compartments (11, 12) according to claim 1, characterised in that at least one of the two labels is peelable, that is to say, it is adapted to be removed before use of said bag (10).

5. A bag (10) for medical purposes having at least two compartments (11, 12) according to one of the preceding claims, characterised in that said opening (16) does not present any horizontal seal on one of the compartments (11, 12).

6. A bag (10) for medical purposes having at least two compartments (11, 12) according to one of claims 1 to 5, characterised in that said opening (16) has no vertical sealing on one of the compartments (11, 12).

7. A bag (10) for medical purposes having at least two compartments (11, 12) according to one of the preceding claims, characterised in that it comprises two compartments (11, 12).

8. An assembly characterised in that it comprises a bag (10) for medical purposes according to one of the preceding claims and in that it comprises a complex/overpack for packaging said filled bag.
